(19) United States
(12) Patent Application Publication
(10) Pub. No.: US 2019/0361580 A1
(43) Pub. Date: Nov. 28, 2019

(54) PROGRESSIVE PRESENCE USER INTERFACE FOR COLLABORATIVE DOCUMENTS

(71) Applicant: Microsoft Technology Licensing, LLC, Redmond, WA (US)

(72) Inventors: Caoimhe Grace Dowling, Bellevue, WA (US); Tien Bui, Seattle, WA (US)

(21) Appl. No.: 15/987,402

(22) Filed: May 23, 2018

(51) Int. Cl. G06F 3/0484; G06F 3/0482; G06F 3/0481

(52) U.S. Cl. CPC G06F 3/0484; G06F 3/04817; G06F 3/0482

(57) ABSTRACT

In non-limiting examples of the present disclosure, systems, methods and devices for assisting with indicating user presence in a shared document are presented. A first instance of a shared document may be displayed, wherein the first instance of the shared document is associated with a first user. An indication of a second user's location in the shared document may be displayed, wherein the first and second users are concurrently accessing the shared document. An input may be received from the first user to display additional information about the second user. Additional information about the second user may be displayed based on the input. The additional information may include a full name of the second user, an activity status of the second user in the shared document, and one or more selectable elements for automatically initiating an electronic communication between the first user and the second user.

### BACKGROUND

The trend of moving information that was traditionally stored on personal computers to the cloud has made shared document editing commonplace. Various applications and application suites allow multiple users to co-author, edit, and review cloud-based shared documents simultaneously. The types of documents that can be modified and reviewed simultaneously include word processing documents, spreadsheet documents, presentation documents, and note taking documents, among others. Although there are many benefits to shared documents, it is difficult for a modifying and/or reviewing user of a shared document to identify the location of other active users in the shared document, determine what activities (e.g., editing, reviewing) the other active users are performing on the shared document, and/or quickly initiate real-time communications with the other active users without having to navigate away from the shared document and/or open a new application.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for assisting with indicating user presence and facilitating electronic communications amongst concurrent users in a shared document. A shared document may be accessed concurrently by a plurality of users via a shared document service. When a first instance of the shared document is displayed on a computing device of a first user (the viewing user), the shared document user interface for that user may include an indication of a location, and an identity, of each other user that is concurrently accessing the shared document. Each user's location in the user interface may correspond to one or more objects that each user currently has selected. Selected objects may include one or more cells in a shared document, one or more rows in a shared document, one or more columns in a shared document, one or more tables in a shared document, one or more pivot tables in a shared document, one or more graphs in a shared document, and/or one or more charts in a shared document.

The indication may comprise bolding or coloring a border of each object that each user currently has selected, and/or highlighting an area of each object that each user currently has selected. A color of the bolding, coloring, and/or highlighting may be different for each concurrent user in the shared document. In some examples, the indication of the identity of each concurrent user in a shared document may include an icon including initials of each user displayed in proximity to an object that each user currently has selected. If two or more users concurrently have a same object selected in the shared document, a plurality of icons with corresponding initials may be stacked in proximity to a corresponding object such that each stacked icon is at least partially visible. The icons may be stacked in an order according to a time that each user selected the concurrently selected object. The icons may be reordered when a user edits a concurrently selected object.

In some examples, a viewing user may indicate that additional information corresponding to another concurrently active user in a shared document be displayed. Upon receiving the indication, the shared document service may cause a full name for the concurrently active user to be displayed on the viewing user's shared document user interface, and/or a contact card for the concurrently active user to be displayed on that user interface. The contact card may include additional contact information for the concurrently active user (e.g., full name, title, company/entity information), a description of one or more objects that are currently selected by the concurrently active user, an activity status associated with the concurrently active user in the shared document, and/or one or more selectable user interface elements for initiating an electronic communication between the viewing user and the concurrently active user. Upon selecting a user interface element for initiating an electronic communication, a messaging window and/or a messaging application may be automatically opened with contact information for a concurrently active user pre-populated in the messaging window/and or messaging application.

### BRIEF DESCRIPTION OF THE DRAWINGS

Non-limiting and non-exhaustive examples are described with reference to the following figures:

FIG. 1 is a schematic diagram illustrating an example distributed computing environment for indicating user presence in shared documents and associated user interface elements for initiating electronic messaging communications with concurrent shared document users.

FIG. 2 illustrates three exemplary progressive user interfaces for indicating user presence in a shared document.

FIG. 3 illustrates exemplary user interface elements for displaying information about concurrent shared document users, and initiating electronic messaging communications with the concurrent shared document users.

FIG. 4A illustrates three exemplary progressive user interfaces for indicating user presence for users that have selected a same object in a shared document.

FIG. 4B illustrates a fourth exemplary progressive user interface for indicating user presence and initiating electronic messaging communications for users that have selected a same object in a shared document.

FIG. 5 is an exemplary method for assisting with indicating user presence and facilitating electronic communications amongst concurrent users of a shared document.

FIGS. 6 and 7 are simplified diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Generally, the present disclosure is directed to systems, methods and devices for displaying information about concurrent users of shared documents, and initiating electronic messaging communications with concurrent users of shared documents through progressive user interface elements. As used herein, a “shared document” describes a document that can be accessed, reviewed, and edited by two or more users from two or more devices. A shared document may be stored in the cloud in association with a shared document service that provides access to the shared document based on authorization credentials of users. As used herein, an “object” of a shared document may comprise one or more cells, one or more columns, one or more rows, one or more tables, one or more graphs, one or more charts, and/or one or more sheet tabs in a document workbook. The shared documents described herein may include word processing documents, spreadsheet documents, presentation documents, and note taking documents, among others.

According to some examples, a first viewing user may access a shared document. When one or more additional users contemporaneously access the shared document with the first user, an indication of a location in the shared document where each of those additional users are may be caused to be displayed on the first user's shared document user interface. The location in the shared document where each of the users are corresponds to one or more currently selected objects in the shared document. In some examples, the indication of the location for each user may comprise highlighting a border of a selected object, highlighting an area of a selected object, bolding the border of a selected object, and/or coloring the area and/or border of a selected object. In additional examples, an icon that identifies each user in the shared document may be displayed in physical proximity to each corresponding selected object. Each icon may identify each user by their corresponding initials (e.g., “JD” for John Doe). In some examples, an icon for a user in the shared document may have a same color as the highlighting or bordering for an object that the user has currently selected, and a different color may be used for identifying each user in the shared document.

The first, viewing, user may provide an input to display contact information for a second user that is concurrently active in the shared document. The input may comprise the first user hovering a mouse cursor over an object that is indicated as being selected by the concurrent user (e.g., hovering the cursor over a selected object for a predefined period of time) or the user's icon associated with that selection, one or more mouse clicks over an object that is indicated as being selected by the concurrent user or the user's icon associated with that selection, and/or a touch on the viewing user's touch-sensitive display in an area of an object that is indicated as being selected by the concurrent user or the user's icon associated with that selection. Upon receiving the first user's input, the contact information for the corresponding concurrent shared document user may be caused to be displayed. In some examples, the contact information that is caused to be displayed may include a first and last name of the user displayed in proximity to an object that the concurrent user has currently selected.

According to some examples, the first user may provide an additional input to have additional contact information about the concurrent shared document user displayed on the first viewer's shared document user interface. The additional input may be a cursor hover input, a mouse click input, and/or a touch input on a touch-sensitive display. The input may correspond to an area indicated on the first user's shared document interface where the concurrent shared document user has currently selected an object. In other examples, the input may correspond to an icon that indicates the identity of the concurrent shared document user (e.g., an icon that includes the concurrent user's initials, an icon that includes the concurrent user's full name) The received additional input may cause an interactive contact card for the second user to be displayed on the first, viewing, user's shared document user interface in proximity to the object in the shared document that is currently selected by the concurrent user.

The displayed interactive contact card may include identifying information about the concurrent user of the shared document (e.g., first and last name, title, company/entity name), a description of one or more objects that the concurrent user currently has selected, an activity status of the concurrent user in the shared document, and one or more selectable user interface elements for initiating an electronic communication between the first, viewing, user and the concurrent user.

The activity status may provide an indication of whether the concurrent user is currently editing content in the shared document, an indication of whether the concurrent user is currently reviewing the shared document, or an indication of whether the concurrent user is idle in the shared document. In some examples, if a user in the shared document is idle for a threshold amount of time, an indication of their location in the document may no longer be displayed on the shared document user interfaces for each other viewing user of the shared document. In this manner, if a user steps away from their computing device without remembering to close a shared document, or if a shared document is left in an unattended browser tab, the other concurrent users in the shared document will not have shared document user interfaces that are cluttered with irrelevant concurrent user indicators.

The one or more selectable user interface elements for initiating an electronic communication between the first, viewing, user and the concurrent user, may include a selectable element for initiating real-time text, voice, and/or audio communications between the first user and the concurrent user, a selectable element for initiating an email communication between the first user and the concurrent user, and/or a selectable element for initiating a real-time group communication between the first user and each other concurrent user in the shared document. According to some examples, upon selecting one of the selectable user interface elements for initiating electronic communications, a messaging window may be caused to be displayed in in the viewing/selecting user's shared document user interface, with the corresponding concurrent user's contact information pre-populated in the “to” field of the messaging window. In additional examples, upon selecting one of the selectable user interface elements for initiating electronic communications, a messaging application separate from the shared document may be automatically opened and the “to” field of a messaging window associated with that application may be automatically populated with the corresponding concurrent user's contact information (e.g., the user's phone number, the user's email address, the user's instant messaging alias).

Technical advantages of the systems, methods, and devices described herein thus include savings in processing costs (i.e., CPU cycles) associated with a viewing user having to otherwise: locate one or more pieces of contact information in a separate contacts application for a concurrent user that the viewing user would like to initiate an electronic communication with, identify an appropriate messaging application for initiating a communication, break the user's document workflow by having to manually open the appropriate messaging application, and manually fill out the “to” field with the manually identified contact information for a user.

In some examples, two or more users may concurrently have a single object selected in a shared document. In that scenario, a shared document user interface of a concurrently viewing user may provide a displayed indication of the two or more users that have concurrently selected the object. In some examples, a plurality of stacked icons that each identify a user that currently has the object selected may be displayed to the viewing user. For example, if viewing user A has a shared spreadsheet application open, and each of users B, C, and D have a same object selected in the shared spreadsheet application, viewing user A's user interface may display three stacked icons in proximity to the selected object, which each icon having the initials of a corresponding user displayed with it. In some examples, plurality of stacked icons may only be displayed upon the viewing user providing an indication to display the icons by interacting with the object (e.g., hovering a cursor over the object, providing a mouse click near the object).

The order of the stacked icons may correspond to a time that each of the users selected the concurrently selected object. For example, if user D was the first user to select the object, user D's icon may be on the top of the stack, if user B was the second user to select the object, user B's icon may be directly below user D's icon in the stack, and if user C was the last of the three users to select the object, user C's icon may have the lowest position in the stack. In some examples, the order of the stack may be automatically modified when a user modifies a concurrently selected object. That is, when a user modifies/edits a selected object, that user's icon may be moved to the top of the stack.

In some examples, if a viewing user selects an icon stack for a concurrently selected object, the stack may be expanded to display a plurality of full names corresponding to each user that has concurrently selected the object. The viewing user may further interact with each expanded icon to have a full contact card for one or more of the concurrently selecting users displayed in proximity to the selected object. As described above, the contact card may include a full name of the user, a title of the user, a company/entity associated with the user, an activity status in the shared document associate with the user, a description of an object that is currently selected by the user, and one or more selectable user interface elements for initiating an electronic communication between the viewing user and the user corresponding to the contact card.

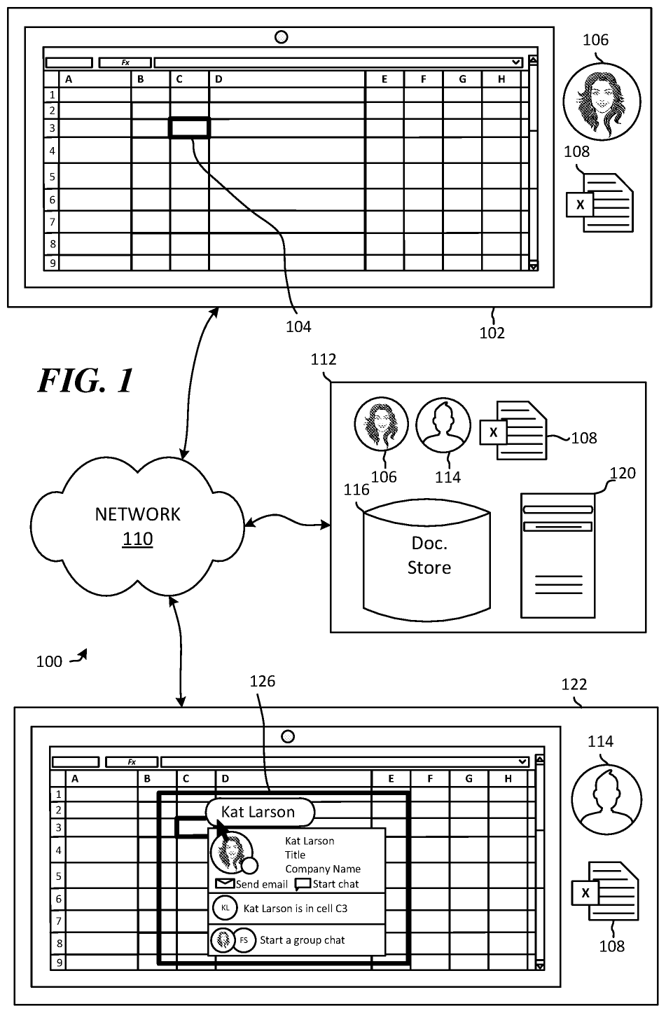

FIG. 1 is a schematic diagram illustrating an example distributed computing environment 100 for indicating user presence in shared documents and associated user interface elements for initiating electronic messaging communications with concurrent shared document users. Example distributed computing environment 100 includes first user environment 102, second user environment 126, network 110, and shared document store and processing environment 112 (which is sometimes referred to herein as a shared document service).

Shared document store and processing environment 112 includes shared document store 116, shared document processing server computing device 120, shared spreadsheet document 108, and for illustrative purposes, users that are currently active in shared spreadsheet document 108—first user 106 (Kat Larson) and second user 114 (Frank Smith). Document store 116 may contain one or more shared documents which may be accessible to users via network 110 according to relevant sharing permissions associated with each document. Shared document processing server computing device 120 may perform one or more operations associated indicating presence information and assisting with electronic communications associated with users of shared documents.

In first user environment 102, first user 106 (Kat Larson) has shared spreadsheet document 108 open on her computing device. Shared spreadsheet document 108 is a shared document accessed from shared document store 116 in shared document store and processing environment 112 via network 110. In this example, first user 106 (Kat Larson) has selected cell object 104 in shared spreadsheet document 108.

In second user environment, second user 114 (Frank Smith) also has shared spreadsheet document 108 open on his computing device. That is, first user 106 (Kat Larson), and second user 114 (Frank Smith) concurrently have shared spreadsheet document 108 open on their respective computing devices. In this example, a plurality of progressive user interface elements 126 are displayed on second user 114's (Frank Smith) computing device for indicating the location of the object that has been selected by first user 106 (Kat Larson) in shared spreadsheet document 108, as a contact card that provides additional contact information about first user 106 (Kat Larson). The contact card includes the name, title, and associated company name of first user 106 (Kat Larson), a description of the object that first user 106 (Kat Larson) currently has selected (i.e., cell object 104), a picture of first user 106 (Kat Larson), an activity status indicator indicative of first user 106's (Kat Larson) activity status in shared spreadsheet application 108, and selectable user interface elements for initiating electronic communications from second user 114 (Frank Smith) to first user 106 (Kat Larson).

In some examples, the progressive user interface elements 126 may be displayed based on one or more inputs. For example, if second user 114 (Frank Smith) hovers his cursor for a threshold amount of time within a threshold distance of cell object 104, a full name of the user that has selected that object in shared spreadsheet application 108 may be caused to be displayed on second user 114's (Frank Smith) application instance of shared spreadsheet application 108. Similarly, if second user 114 (Frank Smith) clicks on the user interface element containing the full name of the user that has selected cell object 104, the contact card and its associated selectable user interface elements may be caused to be displayed on second user 114's (Frank Smith) application instance of shared spreadsheet application 108. Although clicking and hovering inputs are included here for exemplary purposes, other user input types may also be utilized according to the systems, methods and devices described herein for causing one or more of the progressive user interface elements 126 to be displayed. Other examples may include double click inputs, touch-sensitive display inputs, and verbal commands.

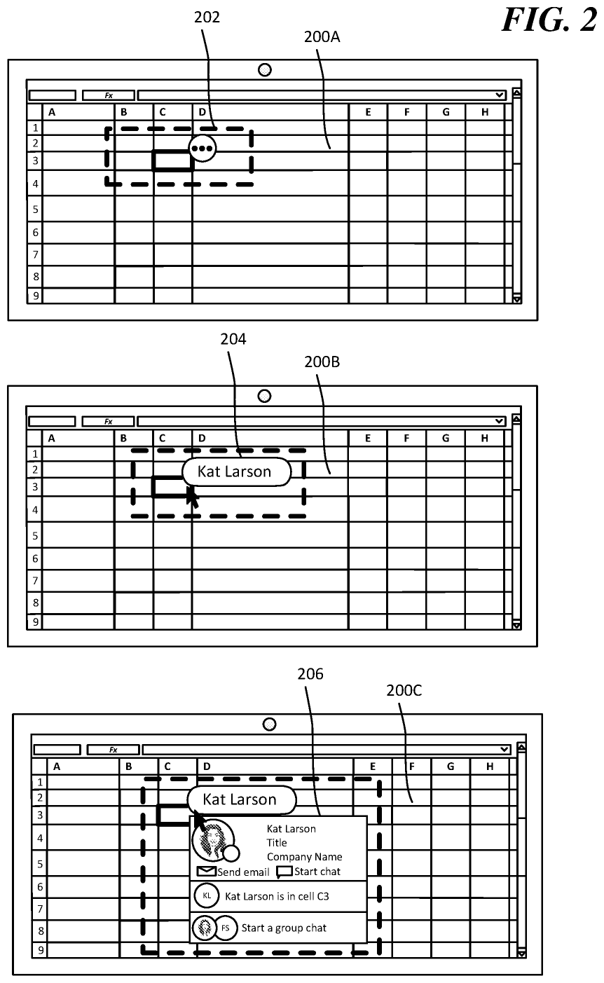

FIG. 2 illustrates three exemplary progressive user interfaces for indicating user presence in a shared document. The three exemplary progressive user interfaces are first user interface 200A, second user interface 200B, and third user interface 200C. Each of the three user interfaces comprise elements for indicating user presence and assisting with initiating electronic communications between concurrent users of a same shared document.

In first user interface 200A, a first user has accessed a shared spreadsheet application, which is displayed in first user interface 200A. First user interface 200A also includes presence and activity indicating user interface elements 202. Presence and activity user interface elements 202 indicate a second concurrently accessing user's current location in the shared spreadsheet application. Specifically, a cell object that the second user has selected is caused to be highlighted or otherwise indicated in first user interface 200A as being accessed by the second user, and a user interface element that indicates that the second user is editing information affecting the selected cell object is caused to be displayed proximate to the selected cell object. In this example, three consecutive dots are included in the user interface element which indicate that the second user is editing information affecting the selected cell object. In some examples, if the second user is not currently editing information affecting the selected cell, the icon with the three consecutive dots may include initials of the second user.

In second user interface 200B, the first user has provided an input to display information about the second user (i.e., the concurrently active user in the shared document). The input may comprise a cursor hover by the first user over the object that the second user has selected, one or more mouse clicks over an area of the object that the second user has selected, a verbal command, and/or a touch input to a touch-sensitive display on the first user's computing device from which the shared document is being accessed by the first user. In this example, based on receiving the input to display information about the second user, user interface element 204 is caused to be displayed on user interface 200B (i.e., the user interface of the first user). User interface element 204 includes the first and last name of the second user in proximity to the object in the shared document that the second user is currently active in.

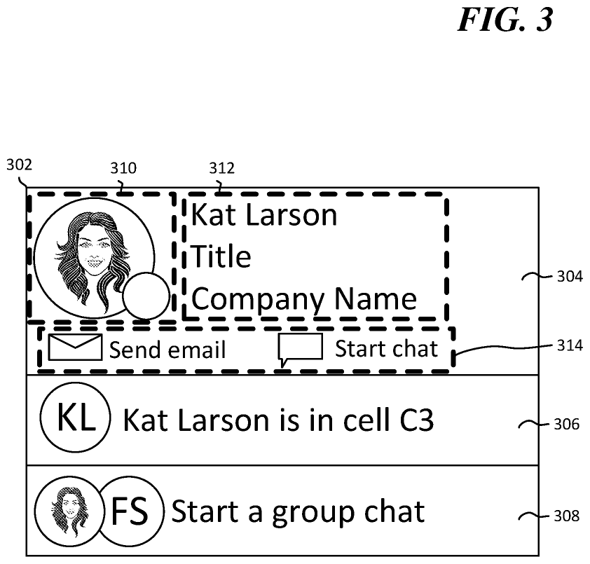

In third user interface 200C, the first user has provided an additional input to display additional information about the second user (i.e., the concurrently active user in the shared document). The input may comprise a mouse click in proximity to user interface element 204 and/or the cell object that the second user is currently active in, a cursor hover over user interface element 204 and/or the cell object that the second user is currently active in, a verbal command, and/or a touch input to touch-sensitive display on the first user's computing device from which the shared document is being accessed by the first user. In this example, based on receiving the input to display additional information about the second user, contact card 206 is caused to be displayed on user interface 200C (i.e., the user interface of the first user). Additional information regarding the content of contact card 206 and its associated functionality in relation to the shared document is described more fully in relation to FIG. 3.

FIG. 3 illustrates exemplary user interface elements for displaying information about a concurrent shared document user, and initiating electronic messaging communications with the concurrent shared document user. The user interface elements are comprised in contact card 302. However, in some examples one or more of the illustrated user interface elements may be independent from contact card 302.

Contact card 302 includes first contact portion 304, second contact portion 306, and third contact portion 308. First contact portion 304 includes user icon 310 and an overlapping activity status icon. The user icon 310 is an image associated with a user account corresponding to contact card 302. The activity status icon provides an indication of the current activity status of the user associated with the contact card 302 in a concurrently shared document with the viewing user. In some examples, the activity status icon may be colored to reflect a current activity status of the user in the shared document. For example, a first color activity status may indicate that the user has recently performed an action and/or navigated in the shared document, a second color activity status may indicate that the user has been idle in the shared document for some amount of time, and a third color activity status may indicate that the user is currently editing the shared document. In some examples, if a user is inactive in a shared document for a threshold duration, that user's presence indicating user interface elements may be removed from each other concurrently viewing user's user interface. Thus, if a user remains inactive for a threshold amount of time due to a user leaving a shared document open on the user's computer while they leave the computer, keeping a shared document open in a browser tab that they are no longer active in, etc., that user's presence indicating user interface elements may be removed from each other concurrently viewing user's user interface. In other examples, the activity status icon may have text associated with it that reflects a current activity status of the user in the shared document.

First contact portion 304 also includes contact information 312 about the concurrently active user corresponding to the contact card. In this example, contact information 312 includes the concurrently active user's first and last name, title, and company name. More or less information may be included in contact information 312. For example, contact information 312 may include a location of the concurrently active user, a school associated with the concurrently active user, and/or an indication of how the concurrently active user is connected to the viewing user.

First contact portion 304 also includes selectable user interface elements 314 for initiating an electronic communication between the viewing user and the user corresponding to the contact card (i.e., Kat Larson). By selecting the “start chat” icon, the viewing user may initiate a real-time text-based, voice-based, and/or video-based communication with the user corresponding to the contact card. By selecting the “send email” icon, the viewing user may initiate an email to the user corresponding to the contact card. In some examples, initiating the email via the “send email” icon may pre-populate the “To” field with the user's email that corresponds to the contact card.

In some examples, the real-time communication initiated by the selection of the “start chat” icon may cause a messaging window for communicating with the user corresponding to the contact card to be surfaced in the shared document. In other examples, the real-time communication initiated by the selection of the “start chat” icon may cause a messaging application to be automatically opened, and in some examples, prepopulated with contact information for messaging the user corresponding to the contact card. In either case, the viewing user's workflow in the shared document is not interrupted to locate a messaging application, start a messaging application, or enter contact information for messaging the user corresponding to the contact card, thereby enhancing the user experience. Additionally, rather than having to open a contacts application to locate the user's contact information that the viewing user would like to message, by selecting the “start chat” icon that contact information can be automatically identified and populated in the relevant “to” field in the electronic communication. By eliminating the need to open a separate contacts application, and perform a search of that contacts application for relevant contact information, the number of computer processing cycles needed to initiate an electronic communication between co-authoring users of the shared document is reduced. Storage costs associated with a contacts application may also be reduced due to the non-necessity of each user having relevant contact information stored on their personal devices. Instead, a central contact repository may be maintained and accessed for presenting contact information about users of a shared document and initiating electronic messages amongst users of a shared document.

Second contact portion 306 provides a displayed indication of an object that the user corresponding to the contact card (i.e., Kat Larson) has currently selected. In this example, the displayed indication indicates that Kat Larson is in, or has currently selected, cell object C3. In examples where a co-authoring user has contemporaneously selected more than one object, second contact portion 306 may indicate each contemporaneously selected object. For example, if Kat Larson contemporaneously selected cell object C3 and a graph in the shared document, the contemporaneous selection of both objects may be indicated in second contact portion 306.

Third contact portion 308 provides a selectable user interface element for initiating a group chat by the viewing user of the shared document with each other user that is concurrently in, or concurrently active in, the shared document. In this example, users that are currently in, or currently active in, the shared document include the viewing user, Kat Larson, and Frank Smith. The viewing user may select the group chat selectable user interface element and initiate a real-time group text-based communication, a group audio-based communication, and/or a group video-based communication with the other concurrently active users in the shared document. As described above with regard to selectable user interface elements 314 for initiating an electronic communication between the viewing user and the user corresponding to the contact card, the selectable user interface element for initiating a group chat may, when selected, cause a messaging window to appear in the shared document with each user's contact information pre-populated in the window, or a group messaging application may be caused to automatically open and be pre-populated with contact information for each of the users in the shared document.

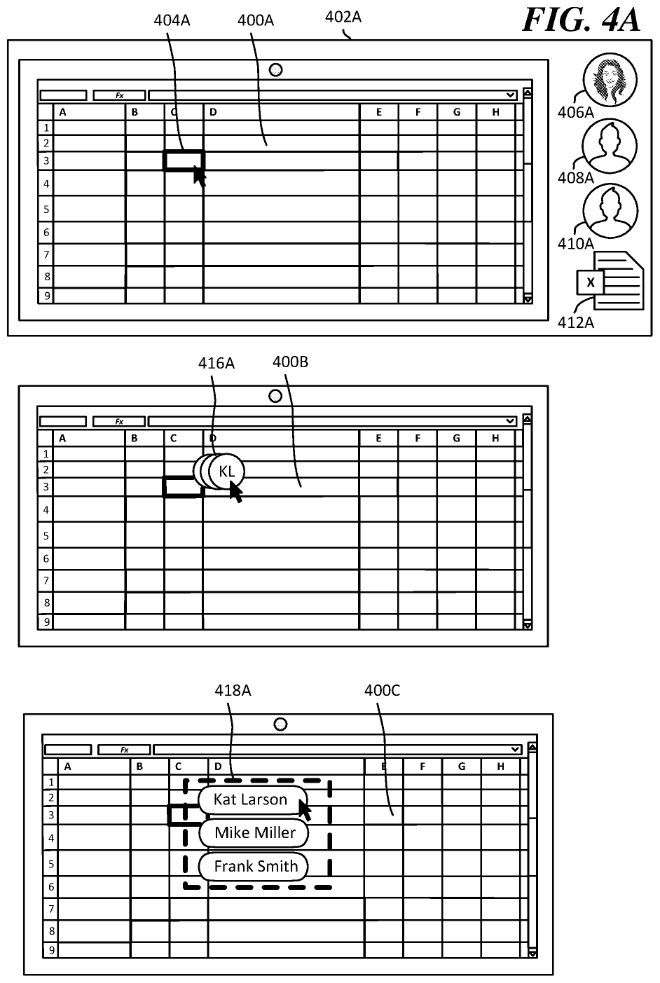

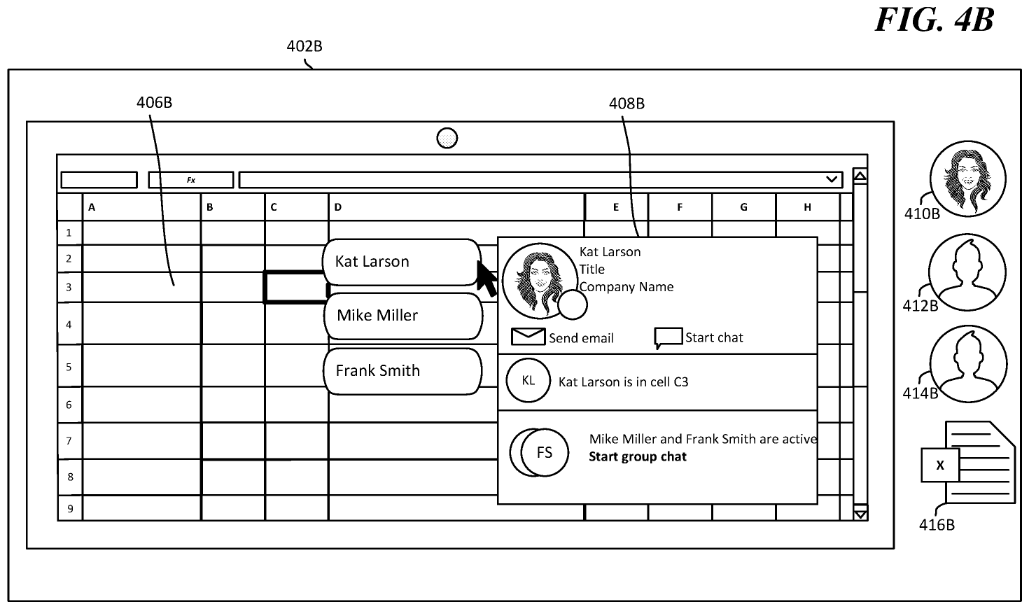

FIG. 4A illustrates three exemplary progressive user interfaces for indicating user presence for users that have selected a same object in a shared document. The three exemplary progressive user interfaces are first user interface 400A, second user interface 400B, and third user interface 400C.

First user interface 400A is in viewer environment 402A, which includes a computing device on which a first user is accessing a shared spreadsheet document 412A depicted in first user interface 400A, and for illustrative purposes, each other user that is currently active in shared spreadsheet document 412A (i.e., Kat Larson 406A, Mike Miller 508A, and Frank Smith 410A). Cell object 404A is highlighted in user interface 400A, indicating to the viewing user that one or more other users in the shared document have currently selected cell object 404A. In some examples, an object may be highlighted in a unique color that indicates that a plurality of other users have currently selected the object. In other examples, an object may have a bold outline that indicates that a plurality of other users have currently selected the object. In still other examples, an object may have a colored outline that indicates that a plurality of other users have currently selected the object.

In this example, the viewing user has provided an input to a shared document service to display additional information about each other user that has currently selected cell object 404A. In some examples, the input may be a hover of a cursor over an area of an object that is concurrently selected by a plurality of users. In other examples, the input may be one or more mouse clicks over an area of an object that is concurrently selected by a plurality of users. In still other examples, the input may comprise a voice command or one or more touches on a touch-sensitive display in an area corresponding to an object that is concurrently selected by a plurality of users.

Upon receiving the input to display additional information about each other user that has currently selected cell object 404A, additional user interface elements are added to user interface 400A, and user interface 400B is caused to be displayed to the viewing user. Specifically, a plurality of stacked icons 416 that are each partially visible are caused to be displayed in proximity to the highlighted object. Each of the plurality of stacked icons 416 indicates a user that has currently selected cell object 404A. In this example, this is indicated by each user's initials being displayed in a corresponding icon. The stacked icons may be stacked in order according to a time that each user in the shared document selected the concurrently selected object (i.e., cell object 404A). That is, the user that selected the concurrently selected object first in time may have a corresponding icon that is stacked on top of each other user's icon, with the user that selected the concurrently selected object last in time having a corresponding icon that is lowest in the plurality of stacked icons 416. Thus, in this example, Kat Larson 406A selected cell object 404A before any of the other users in the shared document, and her icon is on top of the plurality of stacked icons 416.

In some examples, the plurality of stacked icons 416A may be rearranged when a user that has concurrently selected an object modifies the object. That is, when a user that is not first in the plurality of stacked icons 416A, that user's icon may be moved to the top of the stack when the user modifies the concurrently selected object.

Continuing with this example, the viewing user has provided an additional input to a shared document service to display additional information about each other user that has concurrently selected cell object 404A. The additional input may be a hover mechanisms of the viewing user's cursor over the plurality of stacked icons 416A, one or more clicks of the user's mouse in an area of the plurality of stacked icons 416A, a verbal command, or a touch on a touch-sensitive display in an area corresponding to the plurality of stacked icons 416A.

Upon receiving the additional input to display additional information about each other user that has concurrently selected cell object 404A, the plurality of stacked icons 416A are replaced with icons 418A of each user's name that has concurrently selected an object in the shared document as illustrated by user interface 400C. Thus, in this example, an icon with the first user's name (Kat Larson) to select cell object 404A is displayed in proximity to cell object 404A, an icon with the second user's name (Mike Miller) to select cell object 404A is displayed below the first user's name, and an icon with the third user's name (Frank Smith) to select cell object 404A is displayed below the second user's name. As described above with regard to the plurality of stacked icons 416A, icons 418A may be rearranged based on a user that has concurrently selected an object making a modification to that object.

FIG. 4B illustrates a fourth exemplary progressive user interface 406B for indicating user presence and initiating electronic messaging communications for users that have selected a same object in a shared document. In this example, the viewing user has accessed shared spreadsheet application 416B, which is concurrently accessed by Kat Larson 410B, Mike Miller 412B, and Frank Smith 414B. Each of the concurrent users (i.e., Kat Larson 410B, Mike Miller 412B, and Frank Smith 414B) are shown for illustrative purposes on the right side of computing environment 402B, which also includes a computing device that the viewing user is accessing shared spreadsheet application 416B from.

In this specific example, the viewing user has provided a first input to view a plurality of stacked icons for users that have selected cell object C3, the viewing user has further provided an input to expand those stacked icons into full names, and the viewing user has provided yet another input in proximity to the first one of those names (i.e. Kat Larson 410B) to have additional information about the corresponding user displayed in user interface 406B. The input can be a hover input, a mouse click input, or a touch on a touch-sensitive display. Upon receiving the input to display more information about the user, a pop-up window may be caused to be displayed as a contact card 408B for the corresponding user (i.e., Kat Larson 410B).

In this example, contact card 408B includes an image of Kat Larson 410B, title and company name for Kat Larson 410B, an activity status (e.g., idle, active, reviewing, editing) of Kat Larson in the shared spreadsheet application 416B, a description of the location/object in shared spreadsheet document 416B that Kat Larson 410B has currently selected (i.e., cell object C3), and selectable user interface elements for initiating electronic communications between the viewing user and Kat Larson 410B, as well as a selectable user interface element for initiating electronic communications between the viewing user and each other active user in shared spreadsheet document 416B.

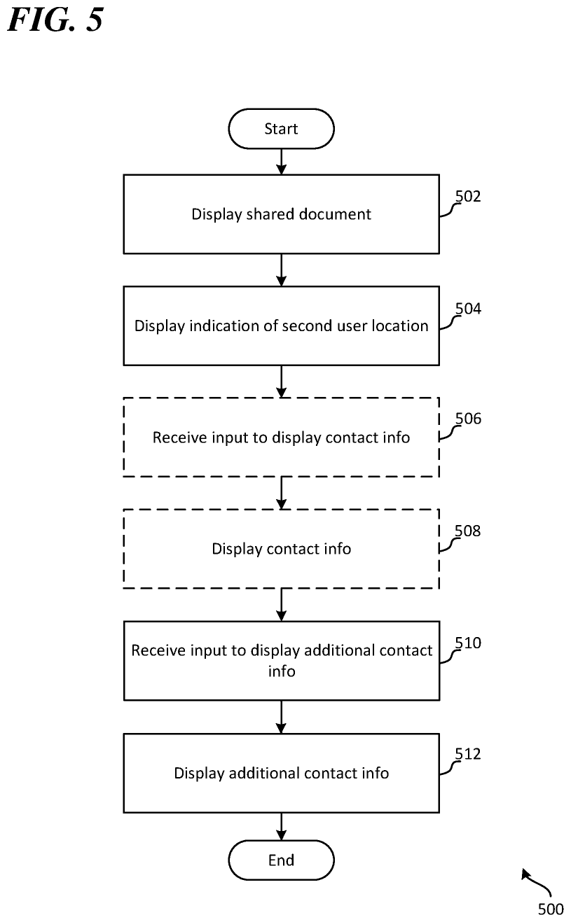

FIG. 5 is an exemplary method 500 for assisting with indicating user presence and facilitating electronic communications amongst concurrent users of a shared document. The method 500 begins at a start operation and flow continues to operation 502.

At operation 502 a shared document is accessed by a first user (also sometimes referred to herein as “viewing user”) and displayed on the first user's computing device. The first user may access the shared document from a shared document service which executes, or assists with execution of, one or more of the operations of method 500. In other examples, each of the steps of method 500 may be performed by the first user's computing device. The shared document may be a word processing document, a spreadsheet document, a presentation document, and/or a note taking document. Prior to the shared document being displayed on the first user's computing device, the shared document service may determine whether the first user has authorization to view the shared document, and only provide that document back to the first user for display and reviewing and/or editing upon determining that the first user is authorized to review and/or edit the document.

From operation 502 flow continues to operation 504 where a second user's location is displayed in the open instance of the shared document on the first user's display. The document service may receive, or may have previously received, a request from a second user to review and/or edit the shared document while the first user has the shared document open. As with the first user, the shared document service, upon determining that the second user is authorized to review and/or edit the shared document, may provide the second user with access to the shared document while the first user still has the shared document open. When the second user selects an object in the shared document, the shared document service may register that selection, and cause an indication of that selection (i.e., the second user's location in the shared document) to be indicated in near real-time on the first user's display of the shared document. The selected object may comprise one or more cells, one or more columns, one or more rows, one or more tables, one or more graphs, one or more charts, and/or one or more sheet tabs in a document workbook.

The object selected by the second user corresponding to the second user's location in the shared document may comprise one or more cells of a spreadsheet application, one or more tables, one or more rows, one or more columns, one or more pivot tables that affect one or more additional objects, and/or one or more graphs. The second user's location/object selection in the document may be indicated on the first user's display by one or more of: bolding the border of the selected object, highlighting the border of the selected object, highlighting the area of the selected object, and/or coloring the border of the selected object. The indication may also include the display of an icon with initials of the second user that has selected the object, in physical proximity to the selected object. The icon may have a same color as a highlight or border that is displayed in association with the selected object.

From operation 504 flow continues to operation 506 where an input is received to display contact information for the second user. In some examples, the first user may provide the input to the first′ user's computing device by hovering a cursor over the object that is indicated as being selected by the second user. The cursor may have to be hovered over the selected object for a threshold amount of time for the input to be received. In other examples, the input may be one or more mouse clicks with the cursor over the selected object. In still other examples, the input may be a touch in the vicinity of the selected object on the first user's computing device.

From operation 506 flow continues to operation 508 where contact information for the second user is displayed on the first user's computing device. In some examples, the contact information that is displayed on the first user's computing device may be a full name of the second user in proximity to the object that the second user has selected. The full name may be encompassed in an icon that replaces an icon with the second user's initials in it that was previously displayed.

From operation 508 flow continues to operation 510 where an input is received to display additional contact information for the second user. The input may comprise a hover input, a mouse click input, or a touch screen input on a touch sensitive display of the first user's computing device. The first user may provide the input on the user interface for the shared document in an area corresponding to either the icon that displays the full name of second user, or the object that the second user has selected.

From operation 510 flow continues to operation 512 where the additional contact information for the second user is displayed on the first user's computing device. In some examples, the additional contact information may comprise a contact card for the second user. The contact card may comprise one or more of: an image of the second user, a full name of the second user, a title and company/organization name of the second user, a description of one or more objects that the second user has currently selected in the shared document, selectable user interface elements for initiating electronic communications between the first user and the second user, and/or a selectable user interface element for initiating a real-time group communication amongst the first user and each other currently active user in the shared document. The user interface elements for initiating electronic communications between the first user and the second user may include an element for initiating an email from the first user to the second user, and an element for initiating a real-time text, voice, and/or video message between the first user and the second user. If the first user selects either element, a messaging interface may be provided to the first user in the shared document for messaging with the second user such that the first user does not have to open a separate messaging application. In other examples, if the first user selects either element, a separate messaging application may be automatically opened and the “to” field may be automatically populated with the relevant contact information for the second user (e.g., a phone number, an instant messaging user name, an email address).

In the above-described manner, the first user does not have to navigate away from the shared document and break the first user's workflow in the shared document if the first user would like to communicate with other users that are concurrently in the shared document. This provides a better user experience for the first user, as well as saving processing resources by not requiring the user to open a contacts application to identify contact information for messaging other users in the shared document. The time and resources saved through these mechanisms are compounded when a group chat between the first user and multiple other users in the shared document is initiated through the selection of the group communication user interface element, as the first user does not have to individually search for each user's contact information, or manually input each user's contact information in the “to” field of the group communication user interface.

From operation 512 flow continues to an end operation and the method 500 ends.

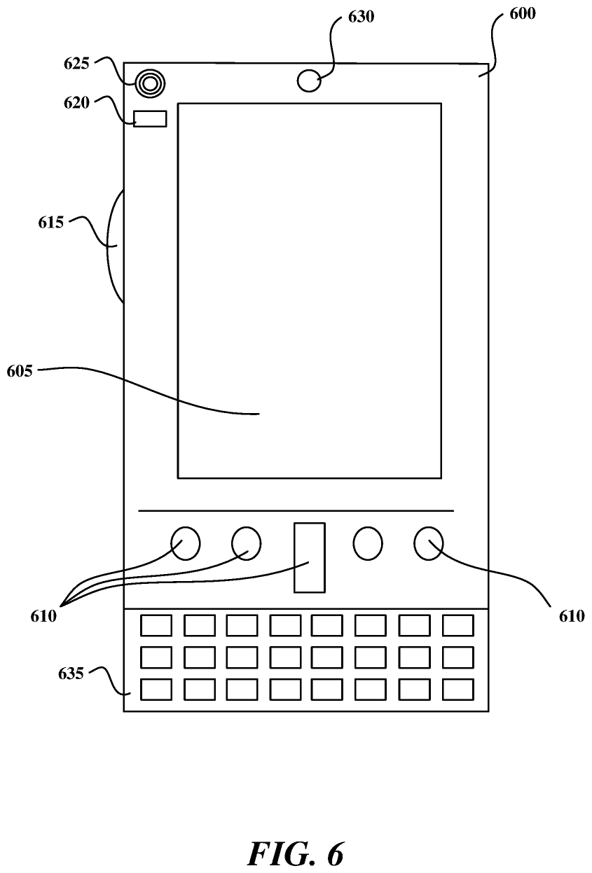

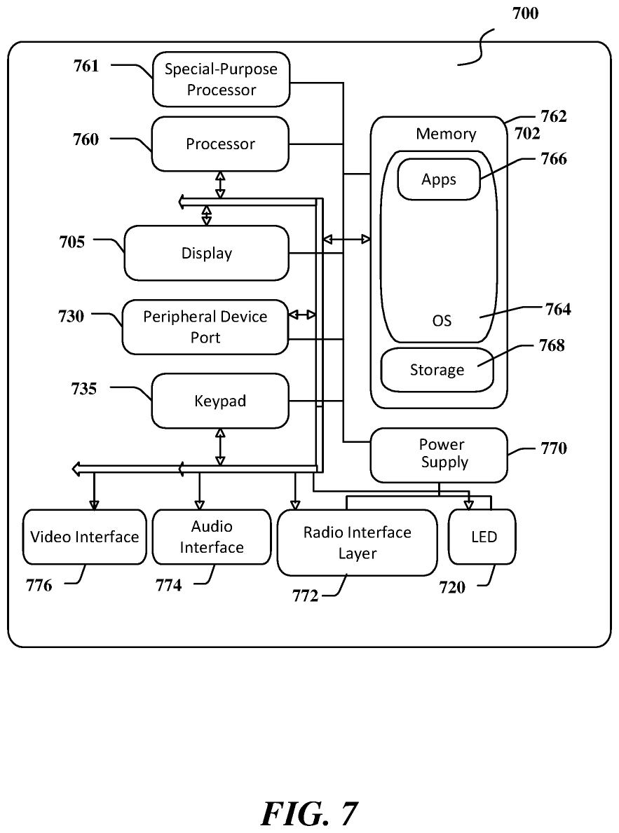

FIGS. 6 and 7 illustrate a mobile computing device 600, for example, a mobile telephone, a smart phone, wearable computer, a tablet computer, an e-reader, a laptop computer, and an augmented reality computer, with which embodiments of the disclosure may be practiced. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or fewer input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including instructions for identifying a target value in a data set.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

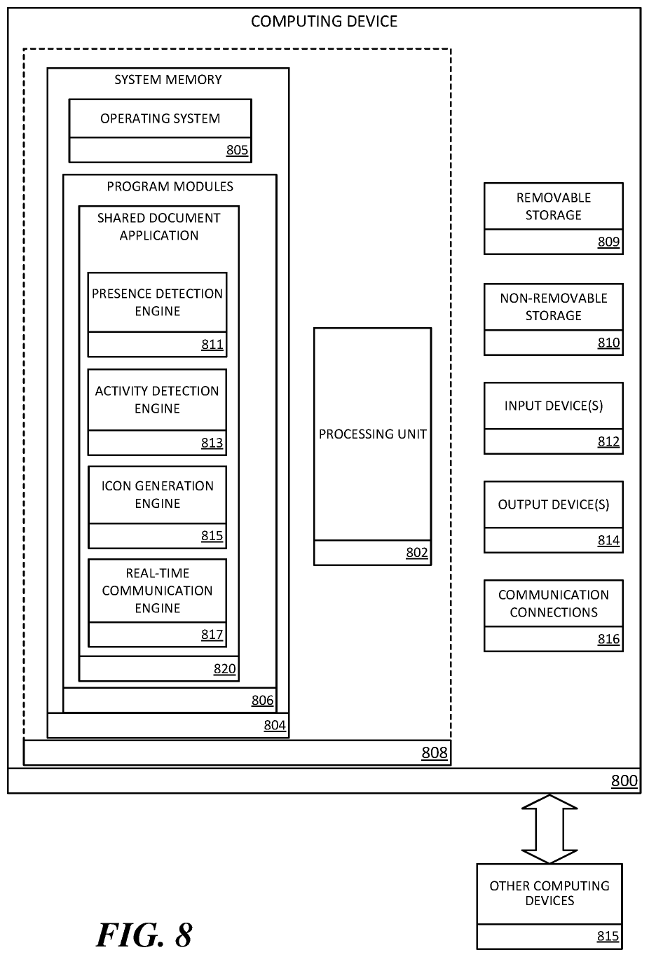

FIG. 8 is a block diagram illustrating physical components (e.g., hardware) of a computing device 800 with which aspects of the disclosure may be practiced. The computing device components described below may have computer executable instructions for assisting with indicating user presence in a shared document. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more productivity application programs. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., shared document application 820) may perform processes including, but not limited to, the aspects, as described herein. According to examples, the presence detection engine 811 may perform one or more operations associated with detecting one or more objects in a shared document that are selected by one or more concurrent users of a shared document. The activity detection engine 813 may perform one or more operations associated with detecting an activity status associated with each concurrent user of a shared document. The icon generation engine 815 may perform one or more operations associated with identifying that a viewing user of a shared document has provided an input to display one or more icons for one or more concurrent users of a shared document in association with the one or more concurrent users' location in the shared document. The real-time communication engine 817 may perform one or more operations associated with identifying contact information (e.g., a phone number, an email address, an instant messaging alias) for one or more shared users of a shared document, automatically opening a messaging window and/or messaging application for initiating an electronic message between a viewing user and one or more concurrent users of a shared document, and/or automatically populating a “to” field with one or more concurrent users' contact information in an associated messaging window and/or messaging application.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 815. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

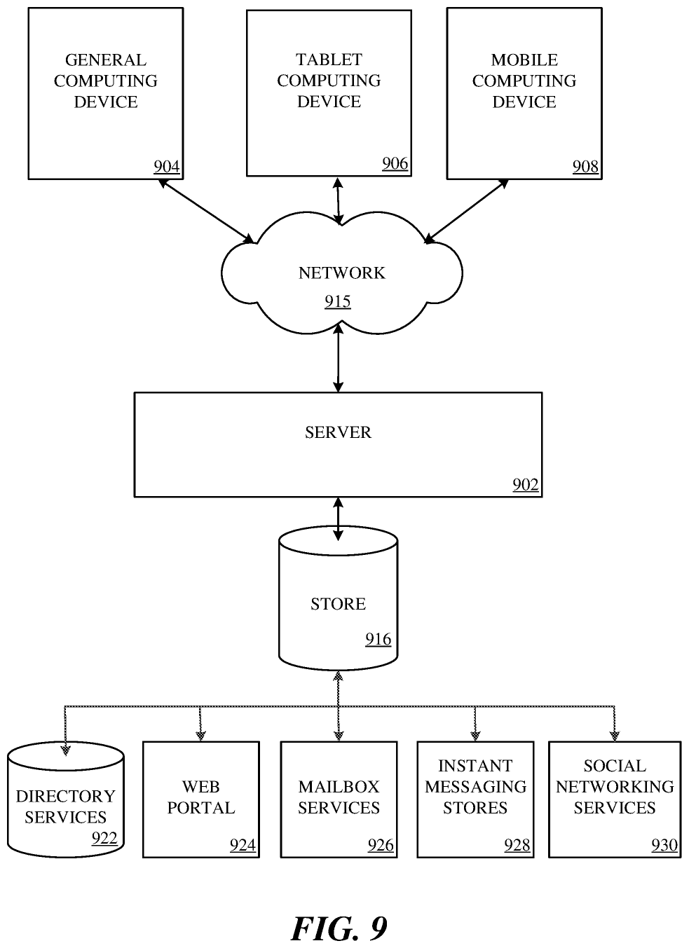

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-8 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method for indicating activity in a shared document, the method comprising:
causing a first instance of the shared document to be displayed, wherein the first instance of the shared document is associated with a first computing device associated with first user credentials for a first user;
causing, in the first instance of the shared document, an indication of a location of a currently selected object by a second computing device in the shared document to be displayed, wherein the first and second computing devices are concurrently accessing the shared document, and wherein the second computing device is associated with second user credentials for a second user;
receiving a first input to display first contact information for the second user;
causing, based on the first input, the first contact information for the second user to be displayed contemporaneously with the displayed indication of the location of the currently selected object by the second computing device in the shared document;
receiving a second input to display additional contact information for the second user, wherein the additional contact information comprises an interactive contact card for the second user; and
causing, contemporaneously with the displayed indication of the location of the currently selected object by the second computing device in the shared document, based on the second input:
the additional contact information for the second user to be displayed, and
a description, in the contact card, of the currently selected object by the second computing device to be displayed.

2. The method of claim 1, wherein the first input is received in physical proximity to the indication of the location of the currently selected object by the second computing device in the shared document.

3. (canceled)

4. The method of claim 1, wherein the displayed contact card comprises a selectable user interface element for initiating a real-time messaging interface between the first computing device and the second computing device.

5. The method of claim 1, wherein the additional contact information for the second user further comprises and an activity status of the second computing device in the shared document, wherein the activity status comprises one of: an editing status, a reviewing status, and an idle status.

6. The method of claim 1, wherein the first contact information comprises a name of the second user.

7. The method of claim 1, wherein the first indication comprises a hover of a cursor for a threshold temporal interval, in the first instance of the shared document, within a threshold distance of the displayed indication of the location of the currently selected object by the second computing device in the shared document.

8. The method of claim 1, wherein the second indication comprises a click of a mouse when a corresponding cursor in the first instance of the shared document is within a threshold distance of the displayed indication of the location of the currently selected object by the second computing device in the shared document.

9. A system for indicating presence in a shared document, the system comprising:
a memory for storing executable program code; and
one or more processors, functionally coupled to the memory, the one or more processors being responsive to computer-executable instructions contained in the program code and operative to:
cause a first instance of a shared document to be displayed, wherein the first instance of the shared document is associated with a first computing device associated with first user credentials for a first user;
cause, in the first instance of the shared document, a plurality of partially overlapping stacked icons to be displayed, wherein the plurality of overlapping stacked icons is arranged such that an icon corresponding to a first in time selection of an object in the shared document is stacked on top of the plurality of partially overlapping stacked icons and an icon corresponding to a last in time selection of the object in the shared document is stacked on the bottom of the plurality of overlapping stacked icons, wherein each of the stacked icons is at least partially visible and identifies one of a plurality of additional computing devices' current location in the shared document, and wherein each of the plurality of additional computing devices' is associated with additional user credentials for a corresponding additional user, and wherein the current location corresponds to the object;
receive a first input at the stacked icons;
cause, based on the received first input, a plurality of selectable user interface elements comprising user names corresponding to each of the stacked icons to be displayed;
receive a second input at a specific one of the selectable user interface elements; and
cause, based on the received second input, a selectable user interface element for initiating an electronic communication with the computing device corresponding to the specific one of the selectable user interface elements to be displayed.

10. The system of claim 9, wherein the processors are further responsive to the computer-executable instructions and operative to:
cause, based on the received second input, an activity status to be displayed in the shared document for a user corresponding to the specific one of the selectable user interface elements.

11. (canceled)

12. (canceled)

13. The system of claim 9, wherein the processors are further responsive to the computer executable instructions and operative to:
reorder the plurality of stacked icons based on one of the plurality of additional computing devices performing an action on the object.

14. The system of claim 13, wherein an icon corresponding to a computing device that performed the action on the object is moved to a top position in the plurality of stacked icons.

15. A computer-readable storage device comprising executable instructions that, when executed by one or more processors, assists with indicating presence in a shared document, the computer-readable storage device including instructions executable by the one or more processors for:
causing a first instance of the shared document to be displayed, wherein the first instance of the shared document is associated with a first computing device associated with first user credentials for a first user;
causing, in the first instance of the shared document, an indication of a location of a currently selected object by a second computing device in the shared document to be displayed, wherein the second computing device is associated with second user credentials for a second user, and wherein the first and second computing devices are concurrently accessing the shared document;
receiving an input to display contact information for the second user;
causing, contemporaneously with the displayed indication of the location of the currently selected object by the second computing device in the shared document, based on the received input:
contact information for the second user to be displayed in an interactive contact card, and
a selectable user interface element, in the interactive contact card, for automatically surfacing a messaging window in the shared document for electronically communicating with the second computing device to be displayed.

16. The computer-readable storage device of claim 15, wherein the displayed contact information further comprises an activity status of the second computing device in the shared document.

17. The computer-readable storage device of claim 16, wherein the activity status comprises one of: an editing status, a reviewing status, and an idle status.

18. The computer-readable storage device of claim 15, wherein the contact information comprises a name of the second user, and wherein the selectable user interface element is selectable for initiating a real-time group communication between the first computing device and the second computing device.

19. The computer-readable storage device of claim 15, wherein the contact information comprises a name of the second user, and wherein the selectable user interface element is selectable for initiating an email communication from an account associated with the first user to an account associated with the second user.

20. The computer-readable storage device of claim 15, wherein the indication of the location of the currently selected object by the second computing device corresponds to one or more objects in the shared document that the second computing device has currently selected, and wherein the one or more objects comprise one or more of: one or more cells in the shared document, one or more columns in the shared document, one or more rows in the shared document, a table in the shared document, and a graph in the shared document.
